(19) United States
(12) Patent Application Publication
(10) Pub. No.: US 2020/0043001 A1
(43) Pub. Date: Feb. 6, 2020

(54) Pet Food Traceability System and Method Therefor

(71) Applicant: Smart Brand Limited, Hong Kong (HK)

(72) Inventor: Man Cheuk Ng, Hong Kong (HK)

(21) Appl. No.: 16/528,684

(22) Filed: Aug. 1, 2019

Related U.S. Application Data
(60) Provisional application No. 62/713,517, filed on Aug. 1, 2018.

(51) Int. Cl. G06Q 20/40; G06K 19/06; H04L 9/30; H04L 9/08

(52) U.S. Cl. CPC G06Q 20/401; G06K 19/06037; G06Q 2220/00; H04L 9/088; H04L 9/30

(57) ABSTRACT

A pet food traceability system includes a client end and a server end. The client end includes a registration and login module, a traceability graphic code generating module, a mall module, and a wallet management module. The server end includes a server and a blockchain. The server is used for saving the process and data of random affairs sent out from the client end on the blockchain, and the blockchain is used for verifying, storing, and outputting the random affair sent out from the client end. Since all random affairs are newly occurred, their information is also random and unpredictable. Furthermore, the process and data of these random affairs are stored in the blockchain. This renders the pet food traceability information immutable, and its authenticity and reliability are ensured. A pet food traceability method is also disclosed.

### CROSS-REFERENCE TO RELATED APPLICATIONS

This application claims the benefit of U.S. Provisional Patent Application No. 62/713,517 filed on Aug. 1, 2018, the entire content of which is hereby incorporated by reference.

### TECHNICAL FIELD

The present disclosure relates to a traceability system, and more particularly to a blockchain-based pet food traceability system.

### BACKGROUND TECHNOLOGY

Pets have become parts of modern urban life. Therefore, people pay more and more attention to the quality and safety of pet foods. Since pet foods involve many raw materials and a long chain of production, any problem in one link may affect the quality and safety of the pet foods. For example, the production of raw materials involves a broad aspect. It involves many kinds of raw materials such as chicken, beef, sweet potato, potato, tapioca, chicken oil, fish oil, beet seed, etc. In the flow and production process of raw materials, it involves many participating parties such as manufacturers, purchasers, logistics, warehouses, dealers, distributors, agents, and processing plants, etc. Any one of the participating parties may have quality and safety issues. However, all participating parties may not be willing to take responsibility. Since the path and system of accountability are very complicated, even if they rely on administrative orders and judicial intervention, it will involve too many departments, areas and industries in order to achieve an effective result. Although there are some existing traceability systems for pet food, they involve only a single piece of traceable information that can be easily altered, and consumers are not able to obtain comprehensive and reliable pet food traceability information.

### SUMMARY

One of the objects of the present disclosure is to provide a pet food traceability system based on blockchain, which utilizes the immutability of blockchain to realize traceability and safety of pet foods.

The technical solution adopted by the present disclosure to solve the technical problem is as follows:

According to one aspect, there is provided a pet food traceability system, including a client end and a server end, the client end including a registration and login module; a traceability graphic code generating module; a mall module; and a wallet management module, and the server end including a server and a blockchain, wherein the server is used for saving process and data of a random affair sent out from the client end on the blockchain, and the blockchain is used for verifying, storing, and outputting the random affair sent out from the client end.

In one embodiment, the traceability graphic code generating module includes a traceability information entry unit; and a traceability graphic code generating unit, wherein the random affair sent out from the traceability information entry unit includes entry of traceability information, and the random affair sent out from the traceability graphic code generating unit includes generation of traceability graphic codes.

In one embodiment, the mall module includes a pet food launching unit; a pet food transaction unit; and a pet food traceability unit, wherein the random affair sent out from the pet food launching unit includes an addition of pet food to an online mall, the random affair sent out from the pet food transaction unit includes a transaction of pet food, and the random affair sent out from the pet food traceability unit includes an application for pet food traceability information inquiry.

In one embodiment, the wallet management module includes a transfer unit and a transaction record inquiry unit, wherein the random affair sent out from the transfer unit includes a request for transfer, and the random affair sent out from the transaction record inquiry unit includes an application for transaction record inquiry.

In one embodiment, the registration and login module includes a registration unit and a login unit, wherein the registration unit is used for sending out a request for user registration to the server, after the user registration is completed, a private key to be saved by a user is generated by encrypting an identity identification number of the user, the private key is encrypted to obtain a public key, and the public key is encrypted to obtain a wallet address of the user; and the login unit is used for sending out a request for login to the server.

In one embodiment, the request for transfer is sent to the server by a transferring party, the request for transfer including the following information: a hash address of a previous transaction; a wallet address of the transferring party and a wallet address of a receiving party; a public key of the transferring party; and a digital signature obtained by encrypting transaction information using a private key of the transferring party.

In one embodiment, the server carries out a verification of the request for transfer after receiving the request for transfer, and records the request for transfer in a block on the blockchain after the request for transfer is verified to be true.

In one embodiment, the blockchain is a private blockchain.

In one embodiment, the traceability information includes one or more information selected from raw material production information, process information, generation time information, ingredient ratio information, packaging information, and factory information.

In one embodiment, the traceability graphic codes are two-dimensional codes containing the traceability information.

According to another aspect, there is provided a pet food traceability method, including providing a client end including a registration and login module, a traceability graphic code generating module, a mall module, and a wallet management module; providing a server end including a server and a blockchain; sending out a request for a random affair from the client end to the server; saving process and data of the random affair on the blockchain by the server; and verifying, storing, and outputting the random affair by the blockchain.

In one embodiment, the sending out step includes sending out the request from a traceability information entry unit of the traceability graphic code generating module, the random affair including an entry of traceability information; and sending out the request from a traceability graphic code generating unit of the traceability graphic code generating module, the random affair including generation of traceability graphic codes.

In one embodiment, the sending out step includes sending out the request from a pet food launching unit of the mall module, the random affair including an addition of pet food to an online mall; sending out the request from a pet food transaction unit of the mall module, the random affair including a transaction of pet food; and sending out the request from a pet food traceability unit of the mall module, the random affair including an application for pet food traceability information inquiry.

In one embodiment, the sending out step includes sending out the request from a transfer unit of the wallet management module, the random affair including a request for transfer; and sending out the request from a transaction record inquiry unit of the wallet management module, the random affair including an application for transaction record inquiry.

The pet food traceability method further includes the steps of using a registration unit of the registration and login module to send out a request for user registration to the server, after the user registration is completed, a private key to be saved by a user is generated by encrypting an identity identification number of the user, the private key is encrypted to obtain a public key, and the public key is encrypted to obtain a wallet address of the user; and using a login unit of the registration and login module to send out a request for login to the server.

In one embodiment, the sending out step includes sending out the request for transfer by a transferring party, the request for transfer including the following information: a hash address of a previous transaction; a wallet address of the transferring party and a wallet address of a receiving party; a public key of the transferring party; and a digital signature obtained by encrypting transaction information using a private key of the transferring party.

The pet food traceability method further includes the steps of carrying out, by the server, a verification of the request for transfer after receiving the request for transfer; and recording the request for transfer in a block on the blockchain after the request for transfer is verified to be true.

In one embodiment, the verification includes the steps of finding, by the server, a previous transaction address, and confirming source of money to be transferred in the request for transfer; calculating and obtaining a wallet address according to the public key of the transferring party, and comparing the obtained wallet address with the wallet address of the transferring party to confirm whether the public key of the transferring party is true; and decrypting the digital signature using the public key of the transferring party, and if the public key of the transferring party is true and the decryption is successful, then the request for transfer is true.

In one embodiment, the generation of traceability graphic codes includes generation of traceability two-dimensional codes containing the traceability information.

The pet food traceability system embodying the present disclosure has the following beneficial effects: since all random transactions initiated by the client are newly occurred, the information of the transactions is also random and unpredictable such that the process and data of all random transactions are saved in a blockchain. It can prevent the pet food traceability information from being altered, and thus ensure the authenticity and reliability of the pet food traceability information.

### BRIEF DESCRIPTION OF THE DRAWINGS

The present disclosure will be further described below in conjunction with the accompanying drawings and embodiments, in which:

FIG. 1 is a block diagram of a pet food traceability system according to an embodiment of the present disclosure;

FIG. 2 is a block diagram of a traceability graphic code generating module of the pet food traceability system according to an embodiment of the present disclosure;

FIG. 3 is a block diagram of a mall module of the pet food traceability system according to an embodiment of the present disclosure;

FIG. 4 is a block diagram of a wallet management module of the pet food traceability system according to an embodiment of the present disclosure;

FIG. 5 is a flow chart showing the interaction process between a client, a server, and a blockchain data storage in the pet food traceability system according to an embodiment of the present disclosure;

FIG. 6 is a schematic diagram of the entry of traceability information in the pet food traceability system according to an embodiment of the present disclosure;

FIG. 7 is a schematic diagram of the generation of traceability graphic codes in the pet food traceability system according to an embodiment of the present disclosure;

FIG. 8 is another schematic diagram of the entry of traceability information in the pet food traceability system according to another embodiment of the present disclosure;

FIG. 9 is a schematic diagram of the entry of relevant information before the pet food is launched according to an embodiment of the pet food traceability system of the present disclosure;

FIG. 10 is a schematic diagram of adding a pet food to an online mall according to an embodiment of the pet food traceability system of the present disclosure;

FIG. 11 is a schematic diagram showing the result of inquiring of pet food traceability information in the pet food traceability system according to an embodiment of the present disclosure;

FIG. 12 is a schematic structural diagram of a block header of a blockchain according to an embodiment of the pet food traceability system of the present disclosure; and

FIG. 13 is a diagram showing the relationship between a public key, a private key, and a wallet address of a registered user according to an embodiment of the pet food traceability system of the present disclosure.

### DETAILED DESCRIPTION OF SPECIFIC EMBODIMENTS

For a better understanding of the technical features, objects and effects of the present disclosure, the embodiments of the present disclosure are described in detail with reference to the accompanying drawings.

The main purpose of the present disclosure is to provide an information recording and inquiring system that can facilitate the traceability of pet food information. It provides an information platform that guarantees the validity of all transactions “contracts” by using blockchain technology. It solves a series of traceability problems of pet foods regarding feed, production, processing and sales, etc. It basically solves the problem of trust between users and manufacturers and middle link manufacturers, as well as the issue of accountability when problems occur. Unlike the traditional centralized structure, the present disclosure is a fully distributed, chained network structure. Since it is a fully distributed structure, it is easier to expand, derive, and fault tolerant than traditional centralized structure. The blocks on a chain do not need to be managed by a central organization, but can be maintained by a fully distributed mechanism that breaks the limitation of the traditional centralized structure.

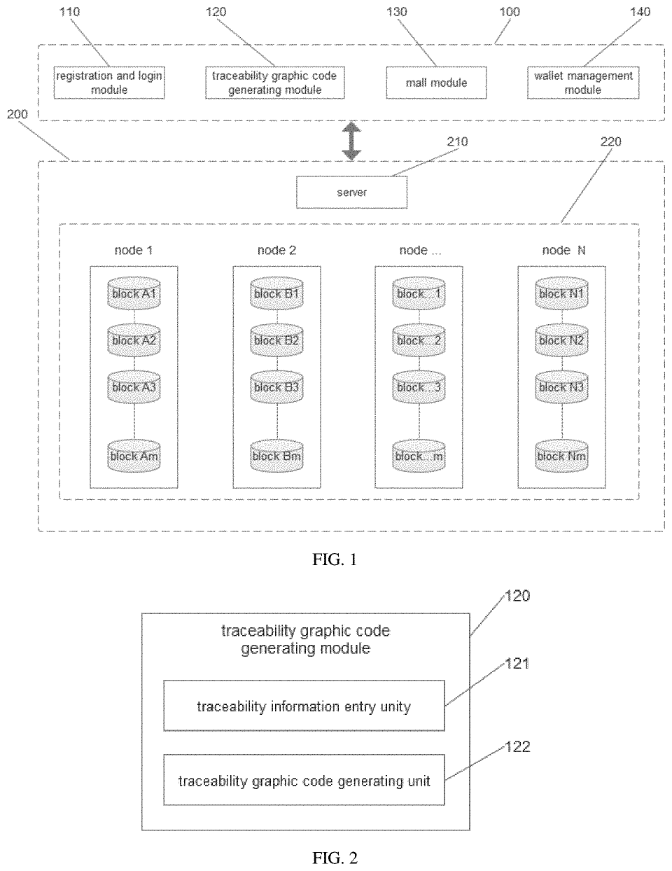

FIG. 1 is a schematic diagram of a pet food traceability system in accordance with an embodiment of the present disclosure. This embodiment of the pet food traceability system may include a client end 100 and a server end 200. The client end 100 may include a registration and login module 110, a traceability graphic code generating module 120, a mall module 130, and a wallet management module 140. The server end 200 may include a server 210 and a blockchain 220. The server 210 may be used for saving the process and data of a random affair sent out from the client end 100 on the blockchain 220. The blockchain 220 may be used for verifying, storing, and outputting the random affair sent out from the client end 100.

As shown in FIG. 2, in the pet food traceability system of the present embodiment, the traceability graphic code generating module 120 may include a traceability information entry unit 121 and a traceability graphic code generating unit 122. The random affair sent out from the traceability information entry unit 121 may include the entry of traceability information, and the random affair sent out from the traceability graphic code generating unit 122 may include the generation of traceability graphic codes.

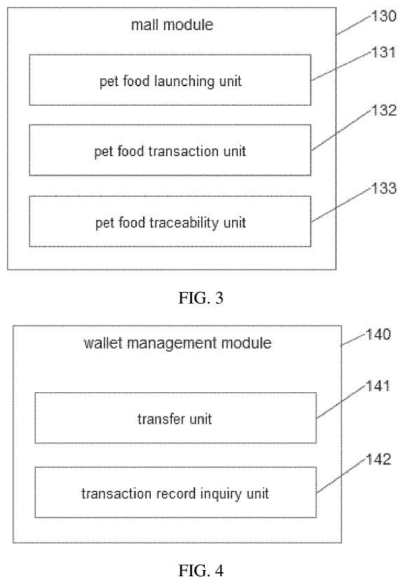

As shown in FIG. 3, in the pet food traceability system of the present embodiment, the mall module 130 may include a pet food launching unit 131, a pet food transaction unit 132, and a pet food traceability unit 133. The random affair sent out from the pet food launching unit 131 may include an addition of pet food to an online mall. The random affair sent out from the pet food transaction unit 132 may include a transaction of pet food. The random affair sent out from the pet food traceability unit 133 may include an application for pet food traceability information inquiry.

As shown in FIG. 4, in the pet food traceability system of the present embodiment, the wallet management module 140 may include a transfer unit 141 and a transaction record inquiry unit 142. The random affair sent out from the transfer unit 141 may include a request for transfer, and the random affair sent out from the transaction record inquiry unit 142 may include an application for transaction record inquiry.

In the pet food traceability system of the present embodiment, the registration and login module may include a registration unit and a login unit. The registration unit may be used for sending out a request for user registration to the server. After the user registration is completed, a private key to be saved by a user may be generated by encrypting an identity identification number of the user. The private key may be encrypted to obtain a public key, and the public key may then be encrypted to obtain a wallet address of the user. The login unit may be used for sending out a request for login to the server.

In the pet food traceability system of the present embodiment, the request for transfer is sent out from a transferring party to the server. The request for transfer may include a hash address of a previous transaction, a wallet address of the transferring party and a wallet address of a receiving party, the public key of the transferring party, and a digital signature obtained by encrypting transaction information by the private key of the transferring party.

In the pet food traceability system of the present embodiment, the server may carry out a verification of the request for transfer after receiving the request for transfer, and may record it in a block on the blockchain after the request for transfer is verified to be true.

In the pet food traceability system of the present embodiment, the verification may include the steps of:
finding, by the server, a previous transaction address, and confirming source of money to be transferred in the request for transfer;
calculating and obtaining a wallet address according to the public key of the transferring party, and comparing the obtained wallet address with the wallet address of the transferring party to confirm whether the public key of the transferring party is true; and
decrypting the digital signature using the public key of the transferring party, and if the public key of the transferring party is true and the decryption is successful, then the request for transfer is true.

In the pet food traceability system of the present embodiment, the blockchain may be a private blockchain.

In the pet food traceability system of the present embodiment, the traceability information may include one or more information selected from raw material production information, process information, generation time, ingredient ratio information, packaging information, and factory information.

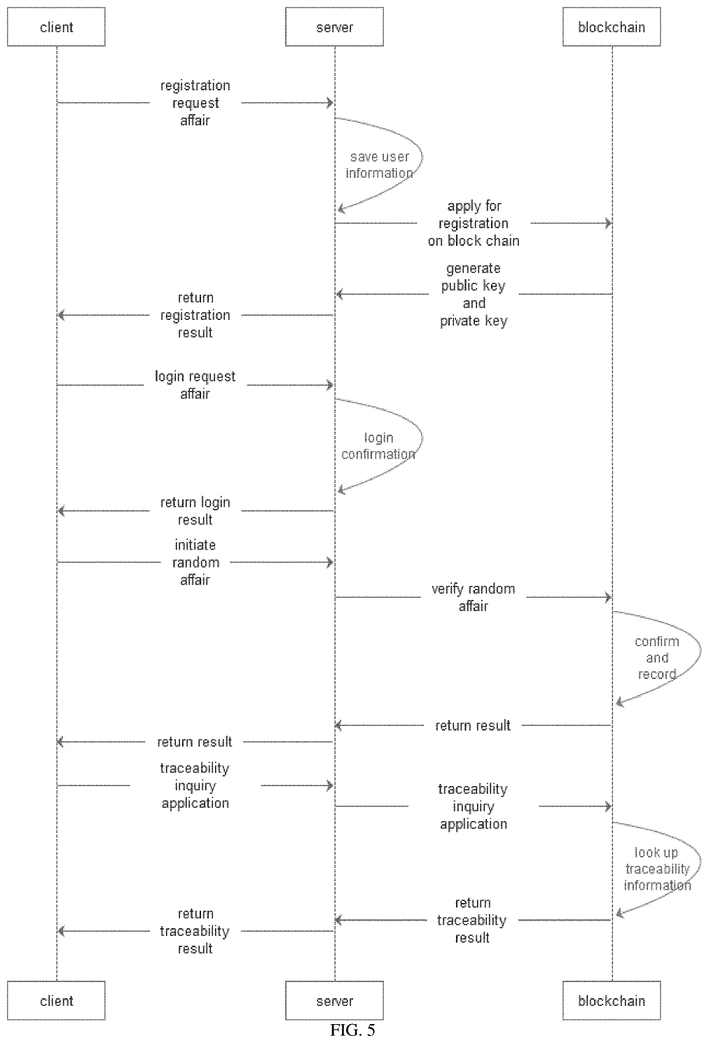

FIG. 5 is a flow chart showing the interaction process of the client end, the server, and the blockchain data storage in the pet food traceability system of the present embodiment, i.e. the interaction process between each module of the client end and the server and the blockchain.

In another embodiment, the pet food traceability system according to the present disclosure may include a client end, a server end, and mall and wallet management modules. The client end may be mainly used for the generation of traceability graphic codes. A user can initiate an affair of requesting for user registration at the server through the client end. The affair of requesting can enable the server end to effectively manage and collect the basic information of the user. The user can log in, respond to the user login affair, and initiate an affair of requesting for user login at the server. Regarding the traceability graphic code generating module, in response to the affair of generating a traceability graphic code initiated by a food manufacturer which has been verified by the system, the manufacturer that has been verified needs to carry out pet food (semi-finished product, finished production) data entry. After the entry of information is completed, a batch of graphic codes of all pet foods is generated for that batch of pet foods by the graphic code generating unit, and then the information is recorded in the blockchain. Regarding the mall module, a manufacturer can initiate at the mall an affair of requesting for pet food. Other users can initiate an affair of requesting purchase of pet food from the mall. All of the transactions taking place at the mall must carry out payment transactions through the wallet management module. The record of information on the transaction will be entered into the blockchain. The user can display the traceability information of the pet food when the pet food is purchased or through offline scanning of the graphic code on the package. Regarding the wallet management module, after successful registration, the wallet management generates a wallet address and a private key for the current user. The private key may be generated only once, and the user needs to save the current private key. The wallet address may be a hex address code obtained by hash encryption of the corresponding public key. All of the transactions “contracts” taking place in the system by the user will be stored in a block on the blockchain at the server end. The server end uses a decentralized, distributed database in which the records are immutable and cannot be deleted. According to an embodiment of the present disclosure, by means of the data platform system of the blockchain, all of the transactions “contracts” of the pet food can be recorded on the blockchain. This can increase confidence of the user in the traceability of pet food, and can reduce potential risk throughout the transaction process.

According to another embodiment of the present disclosure, the client end may include a registration and login module. The registration and login module may include a registration unit and a login unit. The registration unit may be used by a new user to initiate an affair of requesting for an application for user registration at the server. The user needs to provide an identity of the user as well as other basic information in order to ensure the legitimacy of the user. The login unit may be used by a user to initiate login request matter at the server end.

The user needs to provide a login account and a password. The server end verifies whether the user is legitimate and gives a reply to the request. Regarding the traceability graphic code generating unit, in response to the affair of generating a traceability graphic code initiated by a food manufacturer which has been verified by the system, the manufacturer that has been verified needs to carry out pet food (semi-finished product, finished production) data entry. After the entry of information is completed, a batch of graphic codes of all pet foods can be generated for that batch of pet foods through a graphic code generator, and then the current information is recorded on the blockchain. Regarding the mall module, a manufacturer can initiate at the mall an affair of requesting for pet food. Other users can initiate an affair of requesting purchase of pet food from the mall. All of the transactions taking place at the mall must carry out payment transactions through the wallet management module. The record of information of the transaction will be entered into the blockchain. The user can display the traceability information of the pet food when the pet food is purchased or through offline scanning of the graphic code on the package. Regarding the wallet management unit, after successful registration, the client end generates a unique public key and private key based on the identity of the current user. The private key may be used as a proof of the transaction “contract”. After the private key is successfully registered, it will be displayed once, and it needs to be saved by the user. The system does not save the private key of the user. A digital signature should be used in a transaction “contract” by the user with the private key. A hex address code may be obtained by hash encryption using the public key. The address code may be used for recording the wallet address of the current user. The payment address code and the collection address code may be displayed in the transaction “contract”. The transactions “contracts” carried out by the user can be stored in pet food traceability system. The pet food traceability system can be a decentralized, distributed database in which the records are immutable and cannot be deleted.

All the transaction “contract” information may be released to the pet food traceability system, and may be reviewed by all of the nodes in the blockchain of the pet food traceability system. After successful review, the transaction “contract” is effective and can be recorded in a block of a certain node on the blockchain, and the system will notify all nodes to record the data synchronously.

According to an embodiment of the pet food traceability system of the present disclosure, the pet food traceability system can be a blockchain-based data platform.

According to an embodiment of the pet food traceability system of the present disclosure, the wallet management may include at least one of the following: money transfer, generation of transaction “contract”, and asset transfer.

According to an embodiment of the pet food traceability system of the present disclosure, a user can inquire about details of all information on the current pet food, such as raw material production information, processing information, generation time, ingredient ratio information, packaging information, factory information, and logistics information. This can provide the user with information on the entire process of the pet food currently purchased from scratch, and can increase user's approval of safety of the pet food.

According to an embodiment pet food traceability system of the present disclosure, the user of an account is the only one who knows and saves its private key. A private key cannot be solved by using a public key. This can guarantee the safety of the user's account. If the user uses a new device to login, the private key must be used to download the previous data, otherwise the data cannot be obtained.

According to an embodiment of the pet food traceability system of the present disclosure, the affair at the client end may include at least one of the following affairs: generation of graphic code, pet food launching, traceability inquiry, pet food transaction, and money transfer.

According to an embodiment of the pet food traceability system of the present disclosure, the wallet management may be generated by the public key and the private key. The wallet address may be obtained by public key encryption. The algorithm for the generation of the public key, private key and wallet address may include at least one of the following algorithms: hash algorithm, public key encryption algorithm, and SHA256 asymmetric encryption algorithm.

According to an embodiment of the pet food traceability system of the present disclosure, for the generation of a traceability graphic code, a manufacturer needs to send a request for verification of the registered manufacturer to the system. The manufacturer will be verified as to whether it is qualified to be on the chain (the manufacturer's identity is to be approved by the system) through online data review and offline field inspection. When the manufacturer is on the chain, it has the authority to have the function of food traceability graphic code generation.

According to an embodiment of the pet food traceability system of the present disclosure, the affair of the traceability graphic code generating module may include at least one of the following: entry of pet food traceability information and generation of traceability graphic codes.

According to an embodiment of the pet food traceability system of the present disclosure, after a graphic code is generated for the pet food, the mall or the manufacturer can launch that pet food on an online mall. Other customers can view the details of the pet food and the traceability information of the pet food at the online mall. The affair of the mall module may include at least one of the following: pet food launching, transaction of pet food, and inquiry about pet food traceability information.

According to an embodiment of the pet food traceability system of the present disclosure, in the wallet management module, only wallet address, balance information of the wallet, and transaction “contract” information are displayed.

According to an embodiment of the pet food traceability system of the present disclosure, in the transaction “contract” unit of the wallet management module, account A at the client end can request for transfer of money to account B.

According to an embodiment of the pet food traceability system of the present disclosure, a request for transfer of money may include: initiate the transfer of a certain amount of money from the wallet address of account A to account B, and the current transaction information may be packaged and sent to a block in the server.

According to an embodiment of the pet food traceability system of the present disclosure, in a transaction “contract”, the current transaction information and other information may be packaged into transaction information:

I) hash address of the previous transaction;
II) wallet addresses of account A and account B of the present transaction;
III) public key of account A of the transferring party; and
IV) transaction information may be encrypted by the private key of account A of the transferring party to obtain a digital signature.

The transaction “contract” information may be packaged and sent to a block in the server. Verification may be carried out through all of the nodes on the blockchain of the system. If the current transaction information is verified to be true, it may be written into the blocks of all nodes so as to verify whether the transaction is true or not as follows:

I) the server finds the address of the previous transaction and confirms the source of the amount of payment from account A of the current transaction information;
II) find out whether the wallet address calculated and obtained through the public key provided by account A of the transferring party in the transaction package is consistent with the wallet address of account A in order to ensure that the public key is true; and
III) decrypt the digital signature using the public key, and if the decryption is successful and the transaction information can be obtained, then it indicates that the private key is true.

After the above verification and an indication that the current transaction “contract” is true, then the “contract” is effective and can stored in a node on the blockchain for record.

After the transaction “contract” of transferring money from account A to account B is effective, the money in account A will decrease, and a corresponding value in account B will increase.

The transaction “contract” information may be money transfer information, pet food launching, transaction of pet food, etc.

The effectiveness and records of all transaction information generated by the user at the client end will be verified through the blockchain at the server end. The data storage in the server may be a decentralized, distributed database, and its records are immutable and cannot be deleted.

According to an embodiment of the pet food traceability system of the present disclosure, it also provides a system for a user to inquire about the traceability information. If it is found that the pet food is damaged or expired, one can investigate the problem in the corresponding link from the traceability system so that division of responsibility can be carried out. There is no need for a third party to assess who is responsible.

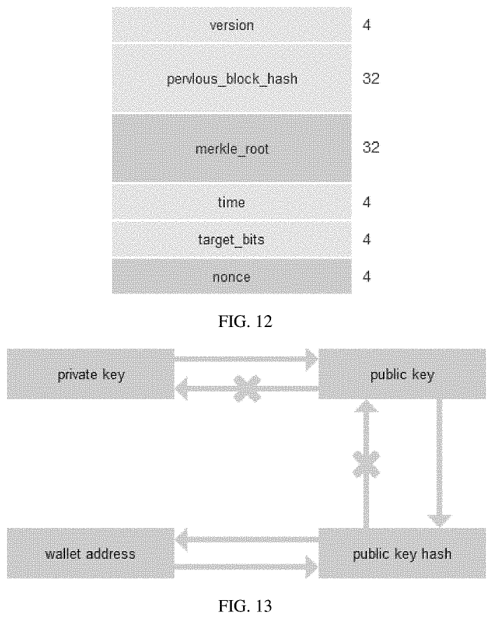

Since the pet food traceability system of the present disclosure is based on blockchain which involves a mining algorithm, a chongmi coin mining algorithm of the present disclosure can be simply summarized as performing two SHA256 hash operations on a block header. If the result obtained is less than a difficulty target specified in the block header, then the mining is successful. FIG. 12 shows the structure and size of a block header. The mining algorithm adopted in the present disclosure may be a Scrypt algorithm. A hash value may also be needed in the Scrypt algorithm. However, more internally-stored resources are needed in a Scrypt calculation process.

According to an embodiment of the pet food traceability system of the present disclosure, the process of writing transactions into a block may include: first, a user logs in at the client end to generate a unique private key and public key address (the private key address should not be leaked out because if someone else takes your private key, your asset may be transferred). The public key can be given to others during the process of initiating a transaction. If the purchase of pet food by a dealer from a merchant is seen as a transaction, then the transaction may be kept in the block.

The transaction party should provide the following information:
hash of the previous transaction (where did you get these bitcoins),
addresses of both parties of the transaction,
public key of the transferring party,
digital signature generated by the private key of the transferring party.

The receiving party needs to verify the information:
find the previous transaction and confirm the source of bitcoins of the transferring party,
calculate the fingerprint of the public key of the transferring party, and confirm that the address of the transferring party is consistent so as to ensure that the public key is true,
use the public key to unlock the digital signature so as to ensure that the private key is true,
after confirming the authenticity of the transaction, the transaction is written into the blockchain.

To complete a transaction, the blockchain data of all miners needs to be synchronized and data consensus needs to be checked. As mentioned, when a node has a different chain from another node, a conflict occurs. In order to solve this problem, the longest effective chain in the present disclosure can be the most authoritative rule. In other words, the longest chain in the network is the most authoritative one. The present disclosure uses this algorithm to reach a consensus between nodes in the network. The algorithm is responsible for checking whether a chain is valid by traversing each block and verifying the hash and proof. If a valid chain with a length greater than the previous valid chain is found, the new chain replaces the previous valid chain. The two endpoints of the chain are registered to the API. One endpoint is used to add an adjacent node, and the other endpoint is used for dealing with conflicts.

According to an embodiment of the pet food traceability system of the present disclosure, the public key and the private key can be realized in the following manner.

First, use a random number generator to generate a “private key”. Generally speaking, this may be a 256-bit number. With a series of digits, one can operate with the chongmi coins in a corresponding “wallet address”. Thus, it must be safely kept.

The “private key” may be processed by SECP256K1 algorithm to generate a “public key”. SECP256K1 is an elliptic curve algorithm. A “public key” can be calculated through a known “private key”. When the “public key” is known, the “private key” cannot be reversely calculated. This is the algorithmic basis for safeguarding the bitcoins.

Same as SHA256, RIPEMD160 is also a hash algorithm. The “public key” can be used to calculate the “public key hash”, and reverse calculation does not work.

The address version number of the previous byte may be linked to the “public key hash” header, and then two SHA256 operations are performed on it. The first four bytes of the result can be used as a check value of the “public key hash”, and is linked to its tail portion.

The result of the previous step may be encoded using BASE58 to obtain a “wallet address”.

FIG. 13 is a diagram showing the relationship of the public key, the private key, and the wallet. During a transaction process, the private key is used to digitally sign the transaction information, and then the encrypted digital signature is decrypted by presenting the public key of the party who proposed the transaction.

Process for Digital Signature:

### 1) Sig=FuncSig(FuncHash(m), dA)

2) dA is a signature private key
3) m is a transaction (or a portion thereof)
4) FuncHash is a hash function
5) FuncSig is a signature algorithm
6) Sig is the resulted signature
7) Function FuncSig produces a signature Sig composed of two values, usually referred to as R and S

### 8) Sig=(R, S)

### Process for Extended Signature:

1) The signature may be created by a mathematical function FuncSig of a signature generated by the composition of the two values R and S.

2) The signature algorithm first generates a temporary private and public key pair. (Note that it is temporary)

3) After transformation involving the signature private key and the transaction hash, a temporary secret key pair may be used to calculate the R and S values.

4) The temporary secret key pair based on random number k may be used as a temporary private key. From k, a corresponding temporary public key P can be generated (Using the calculation P=k G, it is the same as a derived bitcoin public key).

5) The R value of the digital signature is the x* coordinate of the temporary public key P.

6) From there, the algorithm calculates the S value of the signature such that:

S=k⁻¹(Hash(m)+dA*R)mod p

wherein:
k is the temporary private key
R is the x coordinate of the temporary public key
dA is the signature private key
m is transaction data
p is the main order of the elliptic curve

7) Verification is the reciprocal of the signature generation function. The R and S values and the public key are used to calculate the value P, which is a point on the elliptic curve (the temporary public key used during the generation of signature):

P=S⁻¹*Hash(m)*G+S⁻¹*R*Qa

wherein:
R and S are signature values
Qa is the public key of the sending party
m is the signed transaction data
G is the elliptic curve generator point

If the x-coordinate of the calculation point P is equal to R, the verifier can conclude that the signature is valid. When verifying the signature, the private key is neither known nor displayed.

According to an embodiment of the pet food traceability system of the present disclosure, the pet food traceability system uses a decentralized, distributed database, and the data in the database is immutable and cannot be deleted. Preferably, the traceability system may be a blockchain-based data platform. Blockchain refers to a reliable distributed database that is collectively maintained by participating nodes through de-centralization and de-trusting. Its characteristics are immutable and unforgeable. Blockchain is an important concept in the virtual currency-bitcoin financial system. With the development of blockchain technology, it evolves from 1.0 to 2.0, and it is not just applied to the field of payment through virtual currency.

The blockchain mainly uses technologies such as consensus mechanism, cryptography principal and distributed data storage, including:

1) Consensus mechanism: The so-called consensus refers to a process in which multi-party nodes interact under a preset rule through multiple nodes to reach an agreement on certain data, behavior, or process. The consensus mechanism refers to the algorithm, protocol, and rule that define the consensus process. The consensus mechanism of a blockchain has the characteristics of “minority obeys majority” and “equality for all”. “Minority obeys majority” does not absolutely refer to the number of nodes, but also to computing power, number of shares, or other characteristics quantities that a computer can compare. “Equality for all” is that when a node satisfies a condition, all nodes have the priority to propose a consensus result, which can be directly recognized by other nodes, and finally becomes the final consensus result.

2) Cryptography principal: In a blockchain, information may be transmitted according to asymmetric digital encryption technology such as public key and private key to realize mutual trust between the two parties in a transaction. In a specific implementation process, after encrypting of information by one secret key of a public and private secret key pair, only the other secret key can be used to unlock. After one of the secret keys is disclosed (i.e. the disclosed public key), there is no way to calculate the other undisclosed key (i.e. the private key).

3) Distributed storage: Distributed storage on a blockchain is where each participating node has its own independent and complete data storage. Different from the traditional distributed storage, the uniqueness of the distributed storage of a blockchain can be mainly reflected in two aspects: First, each node on a blockchain stores the complete data according to the blockchain structure, whereas the traditional distributed storage generally distributes the data into multiple parts for storage according to certain rules. Second, the storage of each node on a blockchain is independent, equal in status, and relies on consensus mechanism to ensure the consistency of the storage, whereas the traditional distributed storage generally synchronizes data with other backup nodes through a central node. Data nodes can be different physical machines or different instances on a cloud.

Blockchain technology mainly allows all nodes participating in a system to generate a series of data blocks by using cryptography. Each data block contains flowing data of all information in the system for a certain period of time, and links to the next data block through the validity of information saved by verification of encryption. At present, blockchain technology can be divided into three types of applications: public blockchain, private blockchain, and consortium blockchain. For a public chain, such as the blockchain used by Bitcoin, anyone can download and use, participate in the operation and maintenance of the system, and write new data blocks (mining) into the system. A private chain may be a blockchain wherein permission of writing into the system (mining and writing a new data block) is limited to a specific organization. A consortium chain is a blockchain in which the right to access is restricted to a specific number of organizations. In essence, there are no differences among these blockchains, and their implementations are the same. They are decentralized, distributed information storage databases. They use data blocks to replace the traditional Internet dependence on a centralized server so that all data changes and transactions can be recorded on a cloud disk system.

Whether it is a private blockchain, a public blockchain or a consortium blockchain, the first is to implement a data recording system (database) based on blockchain. The data records are linked up together by continuously write new data blocks into the blockchain. It requires a consensus mechanism to allow all nodes to recognize the correctness of the current new data and write into the system.

The blockchains in the pet food traceability system of the present disclosure may be all private blockchains, which are open only to authorized entities who can participate in data maintenance and recording in the blockchain.

In addition, it should be noted that although the pet food traceability system of the present disclosure is described herein as an example of a blockchain-based data platform, the present disclosure is not limited thereto, but may apply all kinds of distributed database that currently exist or may exist in the future, as long as it is ensured that the platform is a decentralized, distributed database and its data is immutable and cannot be deleted.

According to an embodiment of the pet food traceability system of the present disclosure, the registration and login module may include a registration unit and a login unit. The registration unit requires a user to initiate a request for new user registration to the server through the client end. The user is required to fill in basic information such as identity and password, etc. After user registration is successfully, a private key (256 bits) will be generated based on encryption of the identity of the user. The private key needs to be saved by the user. All transactions “contracts” will need the private key of the user. The private key will not be stored in the system. If the Private key is lost, it cannot be retrieved. The private key may be processed by SECP256K1 algorithm to obtain a public key. The public key may go through a hash process and then two SHA256 operations to obtain a wallet address of the user. The wallet address may be used to as an address for receiving and paying money in a transaction “contract”. The login unit requires the user to fill in login information and send a login request to the server. After the login request is successful, the user can perform various random affairs.

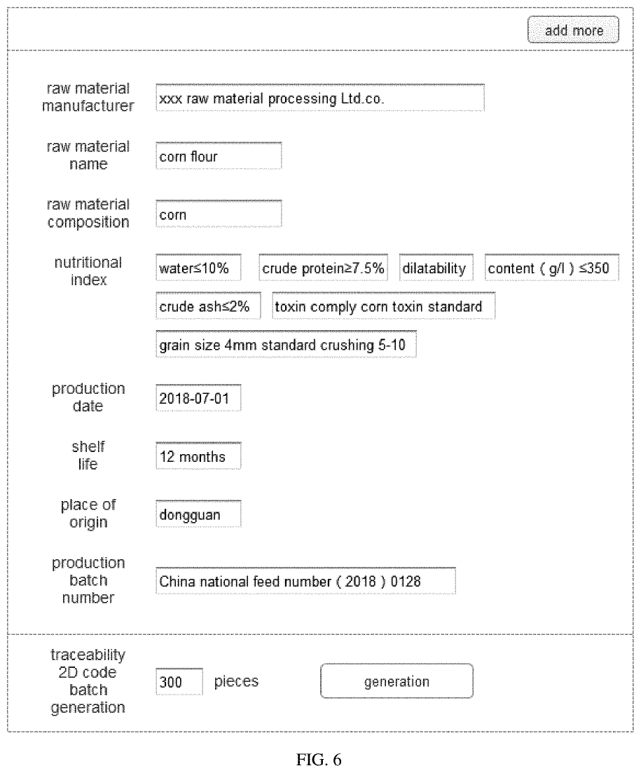

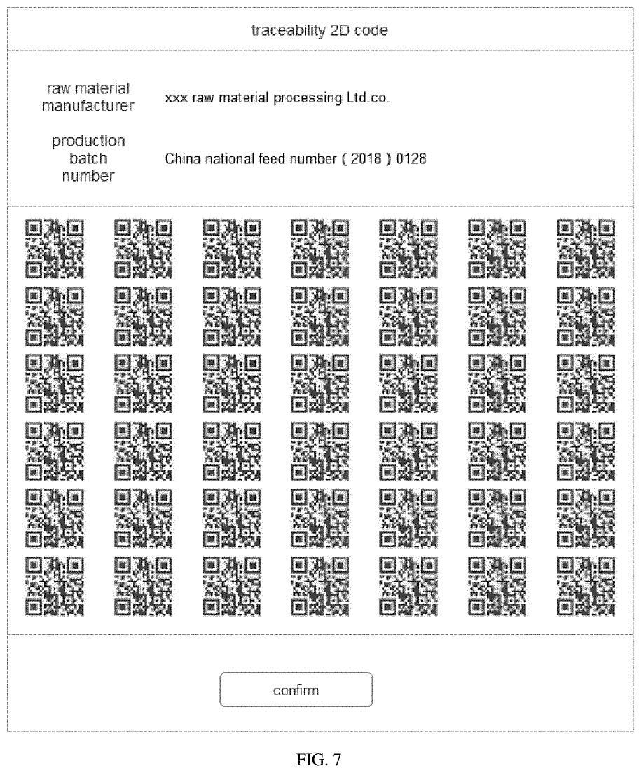

The traceability information entry unit of the traceability graphic code generating module requires a manufacturer to enter the raw materials, ingredients and all other basic information of a batch of pet foods. After the entry is completed, click a “generation” button to send a request for information entry and generation of graphic codes of that batch. FIG. 6 is a schematic diagram of entry of traceability information.

For the traceability graphic code generating unit of the traceability graphic code generating module, after the server receives the request, the entity supervising party performs on-site inspection and sampling detection on all the information of the batch of pet foods. If the detection fails, the request is rejected, and the number of rejections cannot exceed an upper limit (N times). If the detection is successful, the server generates graphic codes in a batch, and writes the graphic codes and the entered information into the blockchain to provide information records for traceability. FIG. 7 is a schematic diagram of a traceability two-dimensional code generated by the system.

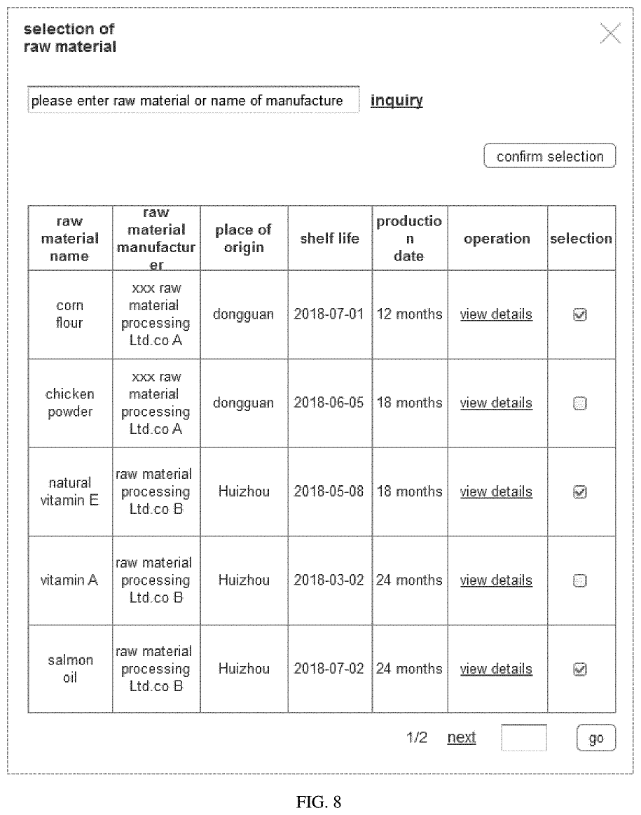

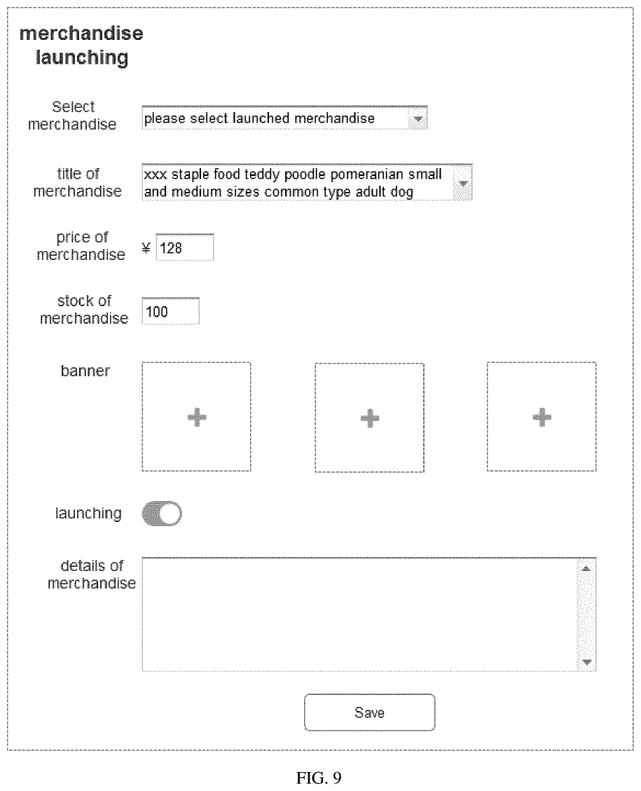

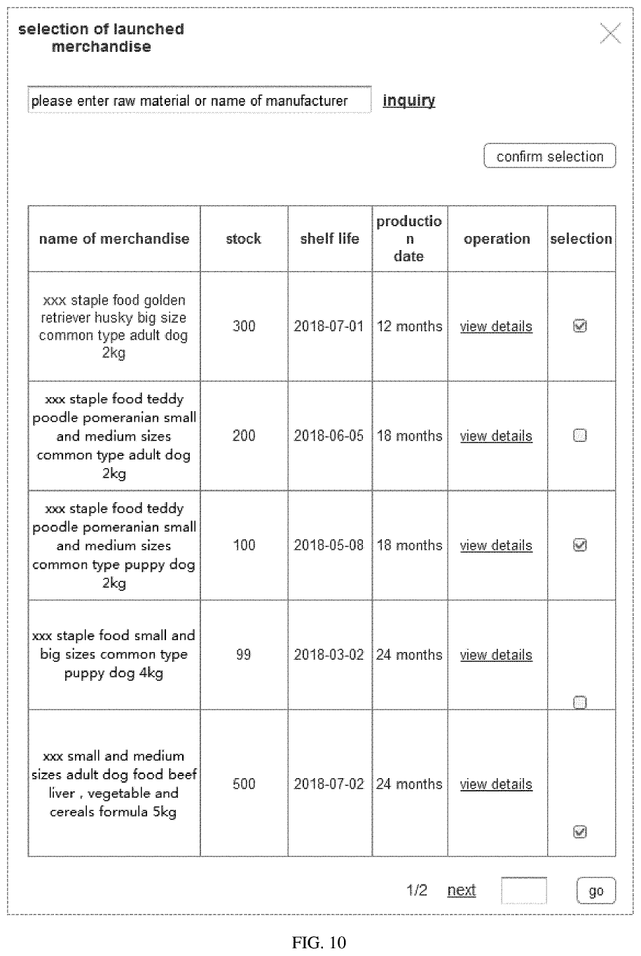

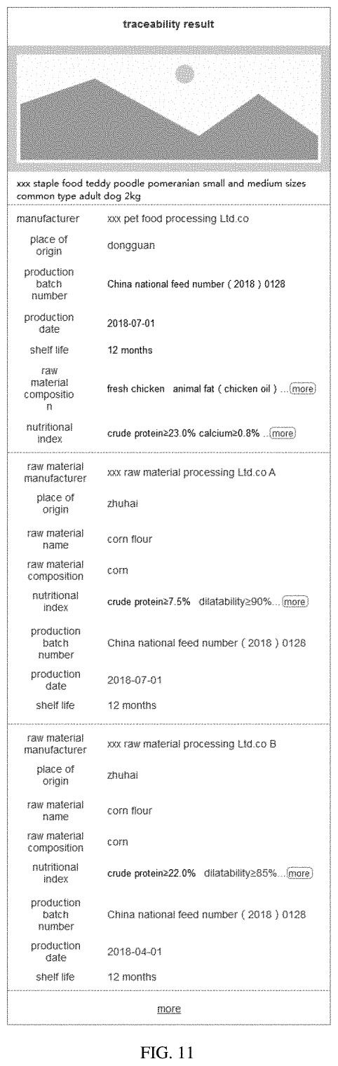

The mall module may include a pet food launching unit, a pet food transaction unit, and a pet food traceability unit. The pet food launching unit requires a manufacturer to enter basic information on the pet food, and click a button to upload the pet food information. Regarding the pet food transaction unit, a consumer can find the required pet food from a list of pet foods, view the pet food details, and then carry out a series of pet food transaction processes such as placing order, paying, receiving goods, returning goods, etc. Regarding the pet food traceability unit, a consumer can look at the pet food details, click a traceability button to view the traceability information of the pet food before purchasing. Alternatively, after receiving the actual goods, the consumer can scan the graphic code on the package using a scanning function of the mall to make traceability inquiry about the pet food. The traceability inquiry process through package graphic code scanning can only be performed once. After the traceability inquiry is finished, the traceability information inquiry about that pet food cannot be repeated. FIG. 8 is a schematic diagram showing the entry of raw material traceability information of pet food before the pet food is launched. FIG. 9 is a schematic diagram showing the entry of relevant information before the pet food is launched. FIG. 10 is a schematic diagram showing the addition of pet food to the online mall. FIG. 11 is a schematic diagram showing the result of inquiry about pet food traceability information.

The transfer unit of the wallet management module may be actually used to handle random affairs between various accounts. A user can initiate a request for an affair. A completed transaction will be counted in the block of each node through the pet food traceability system to achieve the result of completing a transaction.

The transaction record inquiry unit of the wallet management module may be actually used so that a user can inquire about all transaction records of that user through the wallet management module.

Specifically, for example, after a dog food manufacturer A logs in the system and needs to buy chicken from a chicken processing factory B, the dog food manufacturer A selects the unit price and category of chicken provided by the chicken processing factory B through the client end, and selects data of that batch of chicken. After the selection is successful, the dog food manufacturer confirms the current contract by confirming the detailed data of the transaction order, such as 100 pieces of chongmi coins in the transaction (assuming the name of the coin of the system is “chongmi coin”). Then, the transaction request affair may be submitted to the pet food traceability system, and the pet food traceability system carries out an authentication of the transaction request affair. If the authentication fails, the transaction information will not be confirmed and saved. If the authentication is successful, the pet food traceability system will save the transaction “contract” in the blockchain. The dog food manufacturer A and the chicken processing factory B will calculate the remaining chongmi coins in the accounts through the pet food traceability system, and have them displayed at the client end. It does not require to be accounted for by a third party. The chicken processing factory B receives the transaction “contract”, and according to the information in the transaction “contract” will initiate a transaction request affair with the logistics company through the client end. The request affair will be authenticated by the pet food traceability system and saved in the pet food traceability system. The logistics company will be notified by the system to save a series of affairs, such as chicken packaging and sealing in a box, and then arrive at the dog food manufacturer A. The affair request is completed. The affair of logistics involvement will not be described in details. Its principle is basically similar to that of the processing of affairs for A and B.

On the other hand, the user's transaction information and account balance can only be known by the user himself. That is, the user needs to match the saved private key provided to the user after successful registration in order to obtain the user's transaction information and account balance. If the user forgets his or her private key, the user is equivalent to not being able to retrieve all assets in the system. The system will not provide a way to retrieve the private key. If the user needs to change the login system to view transaction information and account balance, the user needs to manually input his own private key, and then generate the public key which in turn generates the wallet address using the private key, so that all transaction information and account balance can be retrieved from the pet food traceability system.

As mentioned above, since all random affairs initiated by the user are newly occurred, their content and information are random and cannot be foreseen and intercepted. Therefore, all random affairs that occur in the accounts can avoid the risks of tampering of transaction and account theft that happen in the existing technology. This can further increase security of the entire system.

According to an embodiment of the pet food traceability system of the present disclosure, pet food preview, material purchasing, factory processing, transport and logistics, pet food storage and delivery, and to the end such as user's purchase and signing upon receipt of all pet foods can be recorded in the blockchain:

1) signing upon receipt of pet food, delivering, and settling of account of a user with pet food token money can be clearly recorded on the blockchain. The advantage of this is that each user can supervise the entire process from production to receipt of goods, and achieve distributed supervision;
2) achieve identity authentication in all aspects as well as electronic contracts between merchants or users;
3) due to the string immutability and encryption characteristics of a blockchain, it is also possible to ensure privacy on the basis of transparency of information; and
4) since all production, transportation and transaction are recorded in the blockchain, it can become a storing and proofing of data for users and manufacturers.

The embodiments of the present disclosure have been described above with reference to the drawings. However, the present disclosure is not limited to the specific embodiments described above. The specific embodiments described above are merely illustrative and not restrictive. Without departing from the purpose of the present disclosure and the scope of protection of the appended claims, those having ordinary skill in the art and with the teaching of the present disclosure can make many modifications that may still fall within the scope of protection of the present disclosure.

What is claimed is:

1. A pet food traceability system, comprising:
a client end; and
a server end,
the client end comprising:
a registration and login module;
a traceability graphic code generating module;
a mall module; and
a wallet management module, and
the server end comprising:
a server; and
a blockchain,
wherein the server is used for saving process and data of a random affair sent out from the client end on the blockchain, and the blockchain is used for verifying, storing, and outputting the random affair sent out from the client end.

2. The pet food traceability system according to claim 1, wherein the traceability graphic code generating module comprises:
a traceability information entry unit; and
a traceability graphic code generating unit,
wherein the random affair sent out from the traceability information entry unit comprises entry of traceability information, and the random affair sent out from the traceability graphic code generating unit comprises generation of traceability graphic codes.

3. The pet food traceability system according to claim 1, wherein the mall module comprises:
a pet food launching unit;
a pet food transaction unit; and
a pet food traceability unit,
wherein the random affair sent out from the pet food launching unit comprises an addition of pet food to an online mall, the random affair sent out from the pet food transaction unit comprises a transaction of pet food, and the random affair sent out from the pet food traceability unit comprises an application for pet food traceability information inquiry.

4. The pet food traceability system according to claim 1, wherein the wallet management module comprises:
a transfer unit; and
a transaction record inquiry unit,
wherein the random affair sent out from the transfer unit comprises a request for transfer, and the random affair sent out from the transaction record inquiry unit comprises an application for transaction record inquiry.

5. The pet food traceability system according to claim 1, wherein the registration and login module comprises:
a registration unit; and
a login unit,
wherein the registration unit is used for sending out a request for user registration to the server, after the user registration is completed, a private key to be saved by a user is generated by encrypting an identity identification number of the user, the private key is encrypted to obtain a public key, and the public key is encrypted to obtain a wallet address of the user; and the login unit is used for sending out a request for login to the server.

6. The pet food traceability system according to claim 4, wherein the request for transfer is sent to the server by a transferring party, the request for transfer comprising the following information:
a hash address of a previous transaction;
a wallet address of the transferring party and a wallet address of a receiving party;
a public key of the transferring party; and
a digital signature obtained by encrypting transaction information using a private key of the transferring party.

7. The pet food traceability system according to claim 6, wherein the server carries out a verification of the request for transfer after receiving the request for transfer, and records the request for transfer in a block on the blockchain after the request for transfer is verified to be true.

8. The pet food traceability system according to claim 1, wherein the blockchain is a private blockchain.

9. The pet food traceability system according to claim 2, wherein the traceability information comprises one or more information selected from raw material production information, process information, generation time information, ingredient ratio information, packaging information, and factory information.

10. The pet food traceability system according to claim 2, wherein the traceability graphic codes are two-dimensional codes containing the traceability information.

11. A pet food traceability method, comprising:
providing a client end comprising a registration and login module, a traceability graphic code generating module, a mall module, and a wallet management module;
providing a server end comprising a server and a blockchain;
sending out a request for a random affair from the client end to the server;
saving process and data of the random affair on the blockchain by the server; and
verifying, storing, and outputting the random affair by the blockchain.

12. The pet food traceability method according to claim 11, wherein the sending out step comprises:
sending out the request from a traceability information entry unit of the traceability graphic code generating module, the random affair requested from the traceability information entry unit comprising an entry of traceability information; and
sending out the request from a traceability graphic code generating unit of the traceability graphic code generating module, the random affair requested from the traceability graphic code generating unit comprising generation of traceability graphic codes.

13. The pet food traceability method according to claim 11, wherein the sending out step comprises:
sending out the request from a pet food launching unit of the mall module, the random affair requested from the pet food launching unit comprising an addition of pet food to an online mall;
sending out the request from a pet food transaction unit of the mall module, the random affair requested from the pet food transaction unit comprising a transaction of pet food; and
sending out the request from a pet food traceability unit of the mall module, the random affair requested from the pet food traceability unit comprising an application for pet food traceability information inquiry.

14. The pet food traceability method according to claim 11, wherein the sending out step comprises:
sending out the request from a transfer unit of the wallet management module, the random affair requested from the transfer unit comprising a request for transfer; and
sending out the request from a transaction record inquiry unit of the wallet management module, the random affair requested from the transaction record inquiry unit comprising an application for transaction record inquiry.

15. The pet food traceability method according to claim 11, further comprising:
using a registration unit of the registration and login module to send out a request for user registration to the server, after the user registration is completed, a private key to be saved by a user is generated by encrypting an identity identification number of the user, the private key is encrypted to obtain a public key, and the public key is encrypted to obtain a wallet address of the user; and
using a login unit of the registration and login module to send out a request for login to the server.

16. The pet food traceability method according to claim 14, wherein the sending out step comprises sending out the request for transfer by a transferring party, the request for transfer comprising the following information:
a hash address of a previous transaction;
a wallet address of the transferring party and a wallet address of a receiving party;
a public key of the transferring party; and
a digital signature obtained by encrypting transaction information using a private key of the transferring party.

17. The pet food traceability method according to claim 16, further comprising:
carrying out, by the server, a verification of the request for transfer after receiving the request for transfer; and
recording the request for transfer in a block on the blockchain after the request for transfer is verified to be true.

18. The pet food traceability method according to claim 17, wherein the verification comprises the steps of:
finding, by the server, a previous transaction address, and confirming source of money to be transferred in the request for transfer;
calculating and obtaining a wallet address according to the public key of the transferring party, and comparing the obtained wallet address with the wallet address of the transferring party to confirm whether the public key of the transferring party is true; and
decrypting the digital signature using the public key of the transferring party, and if the public key of the transferring party is true and the decryption is successful, then the request for transfer is true.

19. The pet food traceability method according to claim 12, wherein the generation of traceability graphic codes comprises generation of traceability two-dimensional codes containing the traceability information.

20. The pet food traceability method according to claim 12, wherein the traceability information comprises one or more information selected from raw material production information, process information, generation time information, ingredient ratio information, packaging information, and factory information.
